(19) United States
(12) Patent Application Publication
(10) Pub. No.: US 2026/0351448 A1
(43) Pub. Date: Nov. 5, 2026

(54) CONNECTION METHOD FOR NEW ENERGY PHOTOVOLTAIC WIRE HARNESS PROTECTIVE LAYER

(71) Applicant: SUNKEAN CABLE CO., LTD., Wuxi (CN)

(72) Inventors: Dongsheng Wang, Wuxi (CN); Mingming Xu, Yancheng (CN); Zhumiao Guo, Zhenjiang (CN); Qi Tang, Wuxi (CN); Jun Dai, Fuzhou (CN)

(21) Appl. No.: 19/713,546

(22) Filed: Jun. 18, 2026

(51) Int. Cl. H01B 13/012; H02S 40/36

(52) U.S. Cl. CPC H01B 13/01263; H02S 40/36

(57) ABSTRACT

Provided is a connection method for new energy photovoltaic wire harness protective layer. Which includes: applying adhesive to outer surfaces of a main cable and a branch cable, or first sleeving outer surfaces of the main and branch cable with heat shrink tubing and heating the heat shrink tubing to wrap around outer surfaces of the main cable and the branch cable; connecting the main cable and branch cable in a cross-shape or T-shape using by ultrasonic welding or adding transition pieces. In the present disclosure, mature industrial steps such as adhesive coating or pre wrapping of heat shrink tubing, ultrasonic welding or transition piece connection, and encapsulation injection molding are used, all of which are suitable for automated continuous production, thereby avoiding problems such as unstable fluidity of the adhesive liquid, long curing time, and difficulty in eliminating bubbles in traditional adhesive processes.

### TECHNICAL FIELD

The present disclosure relates to the field of wire harness processing technologies, and in particular, to a connection method for new energy photovoltaic wire harness protective layer.

### BACKGROUND

In new energy photovoltaic power generation systems, cable connectors and protective layers need to be exposed to outdoor environments for a long time, thereby facing harsh conditions such as ultraviolet radiation, temperature changes, moisture erosion, and wind and sand wear. Therefore, the sealing performance of the wire harness connection and the anti-retraction ability of the insulation layer are directly related to the safe operation and service life of the photovoltaic system.

At present, the existing technology mainly adopts the following two ways for sealing and protecting the connection parts of photovoltaic wire harnesses:
one way is to use adhesive sealing, that is, to inject epoxy resin or silicone inside the connector and form a sealing layer after it solidifies; alternatively, cold shrink tubing can be installed around the connector to achieve sealing through the radial contraction force of the cold shrink tubing; however, the adhesive sealing process has problems such as difficulty in controlling the fluidity of the adhesive solution, long curing time, and difficulty completely eliminating bubbles; the installation of cold shrink tubing requires specialized tools and high requirements for the consistency of an outer diameter of the cable, resulting in cumbersome processing technology and difficulty in ensuring product sealing consistency, thereby affecting the reliability of long-term outdoor use;
the other way is to install connection clips (made of metal or non-metal materials) at the harness connection points, which form mechanical interference between the clips and the cable insulation layer to prevent the cable insulation layer from retracting under long-term thermal stress; however, this way requires extremely high dimensional accuracy and installation technology for clips, rendering it difficult to achieve stable and controllable assembly effects in large-scale production processes, and the feasibility of mass production is low.

In summary, the existing photovoltaic wire harness connection protection technology has defects such as complex process, poor consistency, and difficulty in mass production, which cannot simultaneously meet the sealing reliability and anti-shrinkage performance of the insulation layer required for long-term outdoor use.

### SUMMARY

The purpose of the present disclosure is to propose a connection method for new energy photovoltaic wire harness protective layer to solve the above-mentioned problems.

In order to achieve the above objectives, the present disclosure adopts the following technical solution.

A connection method for new energy photovoltaic wire harness protective layer, including:
step 1: providing a single-layer or multi-layer irradiated main cable and an irradiated branch cable, where a nominal cross-sectional area of a conductor of the branch cable is less than or equal to a nominal cross-sectional area of a conductor of the main cable;
step 2: applying adhesive to outer surfaces of the main cable and branch cable, or first sleeving outer surfaces of the main cable and branch cable with heat shrink tubing and heating the heat shrink tubing to wrap around the outer surfaces of the main cable and branch cable;
step 3: connecting the main cable and branch cable into a cross-shaped or T-shaped by ultrasonic welding or by adding transition pieces;
step 4: wrapping outer surfaces of connected main cable and branch cable with adhesive to form a single-layer or multiple-layer protective layers; where the protective layer is made of thermosetting or thermoplastic material;
where the adhesive or heat shrink tubing is used to bond a cable insulation layer with the protective layer to achieve sealing and prevent the cable insulation layer from retracting.

In some embodiments of the present disclosure, the conductors of the main cable and branch cable are one of copper conductors, aluminum conductors, or copper-clad aluminum conductors.

In some embodiments of the present disclosure, the thermosetting material is at least one of epoxy-based materials, phenolic based materials, or polyester based materials or equivalent categories material.

In some embodiments of the present disclosure, the thermoplastic material is at least one of equivalent materials in Thermoplastic Rubber, (TPV) or Polypropylene, (PP) class materials.

In some embodiments of the present disclosure, the protective layer is a single-layer structure or a multi-layer composite structure.

In some embodiments of the present disclosure, when using adhesive in step 2, the adhesive is directly applied to an outer surface of the cable insulation layer;
when using heat shrink tubing in step 2, the heat shrink tubing is tightly wrapped around the outer surfaces of the cables by heating.

In some embodiments of the present disclosure, the connection way between the main cable and the branch cable is selected as a cross-shaped connection or a T-shaped connection according to actual wiring requirements.

In some embodiments of the present disclosure, the method is used for cable connection and sealing protection in long-term outdoor use scenarios of new energy photovoltaic systems.

In summary, due to the adoption of the above technical solution, the beneficial effects of the present disclosure are as follows:
1. the present disclosure adopts mature industrial steps such as adhesive coating or pre-wrapping of heat shrink tubing, ultrasonic welding or transition piece connection, and encapsulation injection molding, all of which are suitable for automated continuous production, avoiding problems such as unstable fluidity of the adhesive solution, long curing time, and difficult elimination of bubbles in traditional adhesive processes, and eliminating the need for manual operation and specialized tools like cold shrink tubing installation;
2. the ultrasonic welding or transition piece connection method in the present disclosure has a simple structure, high repeatability and positioning accuracy, and can achieve standardized operations; therefore, the present disclosure not only reduces errors caused by manual intervention, but also improves production efficiency and yield, thereby achieving the unity of mass production and product consistency, and providing reliable technical support for the large-scale deployment of new energy photovoltaic systems.

### BRIEF DESCRIPTION OF DRAWINGS

In the following description of exemplary embodiments in combination with the accompanying drawings, more details, features, and advantages of the present application are disclosed.

FIG. 1 is a position schematic diagram of a cable and an insulation layer of the present disclosure.

FIG. 2 is a position schematic diagram of an adhesive of the present disclosure.

FIG. 3 is a position schematic diagram of a heat shrink tubing of the present disclosure.

FIG. 4 is a position schematic diagram of an ultrasonic welding point of the present disclosure.

FIG. 5 is a position schematic diagram of a welding-class transition piece of the present disclosure.

FIG. 6 is a position schematic diagram of a clamping-class transition piece of the present disclosure.

FIG. 7 is a schematic diagram of a main cable and a branch cable of the present disclosure.

FIG. 8 is a method flowchart of the present disclosure.

### DESCRIPTION OF EMBODIMENTS

Below, several embodiments of the present application will be described in more detail with reference to the accompanying drawings, to enable those skilled in the art to implement the present application. The present application may take many different forms and purposes and should not be limited to the embodiments described herein. Provide these embodiments to make the present application comprehensive and complete, and fully convey the scope of the present application to those skilled in the art. The embodiments described do not limit the scope of the present application.

Unless otherwise defined, all terms used in this specification (including technical and scientific terms) have the same meanings as those commonly understood by those skilled in the art to which the present application belongs. It will be further understood that terms such as those defined in commonly used dictionaries should be interpreted as having a meaning consistent with their meaning in the relevant field and/or the context of this specification, and will not be interpreted in an idealized or overly formal sense unless explicitly defined in this specification.

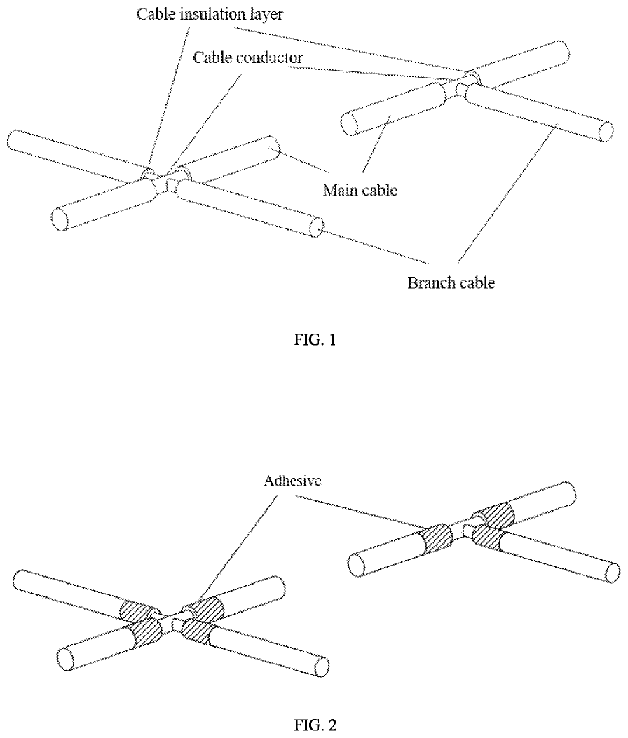

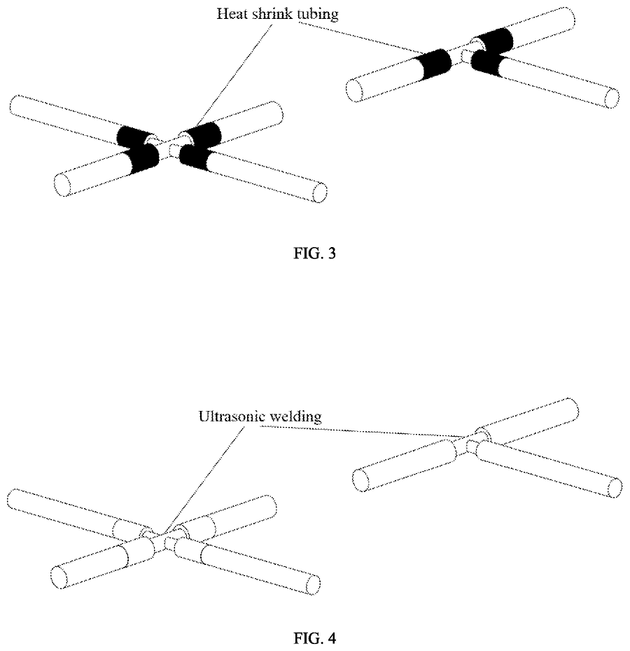

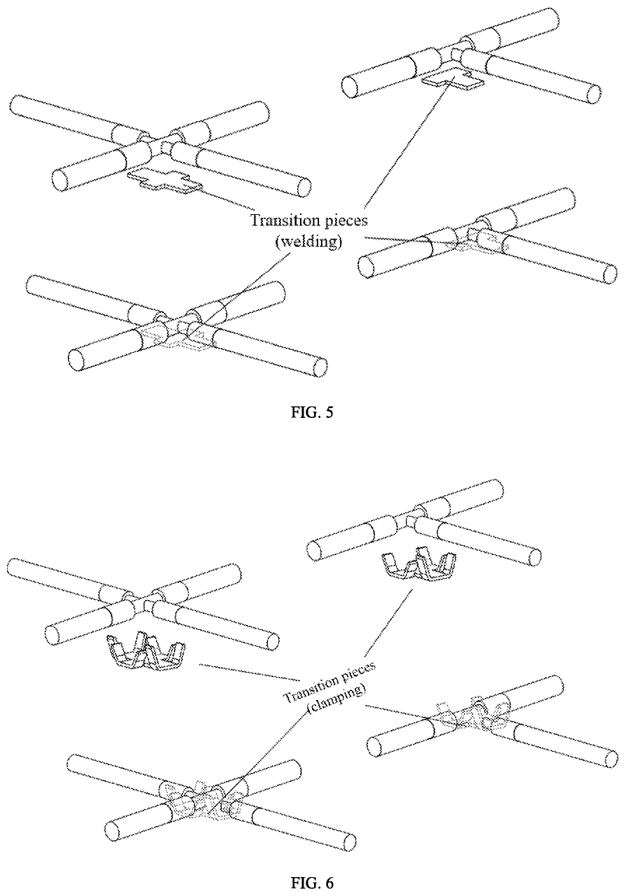

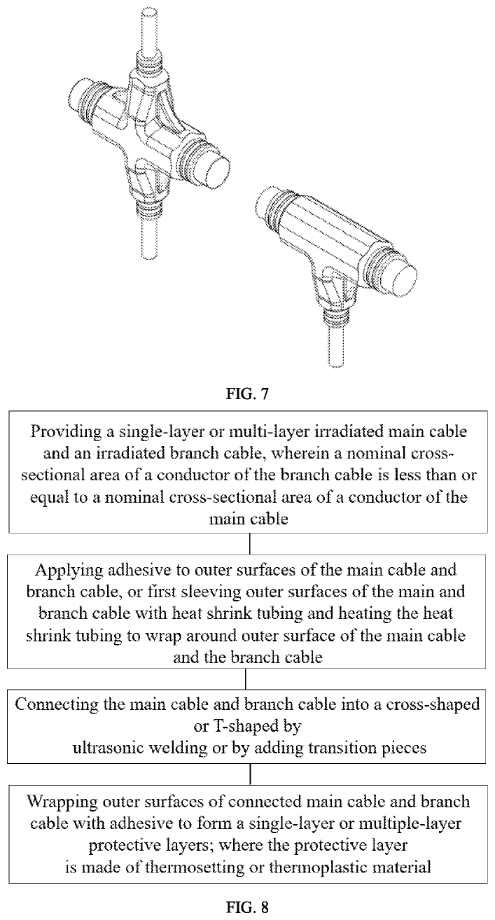

The specific implementation mode will be described in detail with reference to FIGS. 1-8.

This embodiment provides a connection method for new energy photovoltaic wire harness protective layer, which specifically includes the following steps:
step 1, preparing cables: selecting a radiation cross-linked main cable and a radiation cross-linked branch cable, both of which are multi-layer radiation insulated structures; a conductor of the main cable and a conductor of the branch cable are both made of copper conductor; before connecting, cleaning surfaces of connection parts of the main cable and branch cable with anhydrous alcohol to remove oil stains and impurities;
step 2, applying adhesive: applying a layer of adhesive evenly on an outer surface of a connection area between the main cable and the branch cable, with a coating thickness controlled at a preset thickness; after coating, letting it stand and allowing the adhesive to dry;
step 3, cable connection: placing the main cable and branch cable in a T-shape, and using an ultrasonic welding machine to weld the conductors of two cables together; after welding, a conductive and reliable T-shaped connection structure is formed;
step 4, encapsulation protection layer: placing a connection part of the welded cable in an injection mold and using thermoplastic TPV material for encapsulation injection molding to form a single-layer protection layer; the encapsulation protective layer completely covers a welding area and an insulation layer area coated with the adhesive, and extends to a predetermined length of outer surfaces of insulation layers of two ends of the two cables;
step 5: cooling naturally to room temperature.

This embodiment uses adhesive to bond the cable insulation layer and the encapsulation protective layer into a whole, thereby effectively preventing water vapor intrusion and insulation layer shrinkage during long-term outdoor use. At the same time, ultrasonic welding and encapsulation injection molding processes are suitable for automated mass production, ensuring product consistency and reliability.

In an implementation mode, where step 2 does not use the adhesive, but first sleeve heat shrink tubing on the main cable and branch cable respectively, then move the heat shrink tubing to the connection area and heat the heat shrink tubing to tightly wrap around outer surfaces of the main cable and branch cable;
after the welding is completed in step 3, performing encapsulation injection molding on outsides of the heat shrink tubing, using thermoplastic TPV material as the encapsulation material.

This embodiment can also achieve a tight fit between the cable insulation layer and the encapsulation protection layer, thereby preventing the insulation layer from retracting and sealing failure.

In an implementation mode, where step 3 ultrasonic welding connection is replaced with transition pieces connection; alloy pieces are used as the transition pieces, and the main cable conductor, branch cable conductor, and transition pieces are stacked together to form a cross shaped connection structure through crimping;
remaining steps are the same as in above embodiment; this embodiment is applicable for connecting conductors of the same and different materials, ensuring the stability of the connection site.

In an implementation mode, where step 4, the encapsulation protective layer is a double-layer structure, with an inner layer made of thermosetting polyester material and an outer layer made of thermoplastic PP material;
double-layer injection molding is completed through secondary injection molding, and the double-layer protective layer further improves mechanical strength and weather resistance, especially suitable for outdoor environments with high ultraviolet radiation and severe temperature differences.

The above only describes some exemplary embodiments of the present disclosure through explanation. It is beyond doubt that those skilled in the art can modify the described embodiments in various ways without departing from the spirit and scope of the present disclosure. Therefore, the above drawings and description are illustrative in nature and should not be construed as limiting the protection scope of the claims of the present disclosure.

It should be noted that in this specification, terms such as “first” and “second” are only used to distinguish one entity or operation from another, and do not necessarily require or imply any actual relationship or order between these entities or operations. Moreover, terms “including”, “having”, or any other variation thereof are intended to encompass non-exclusive inclusion, such that a process, method, item, or device that includes a series of elements includes not only those elements, but also other elements not explicitly listed, or elements inherent to such process, method, item, or device. Without further limitations, the element limited by the statement “including one...” does not exclude the existence of other identical elements in the process, method, item, or device that includes the element.

It should be noted that in the various embodiments of the present application, the size of the sequence numbers of the above processes does not imply the order of execution. The order of execution of each process should be determined by its function and internal logic, and should not constitute any limitation on the implementation process of the embodiments of the present application.

Besides that, the functional units in various embodiments of the present application can be integrated into one processing unit, physically exist separately, or integrate two or more units into one unit.

The above is only a specific implementation of the present application, but the protection scope of the present application is not limited to this. Any skilled person familiar with the technical field can easily think of changes or replacements within the technical scope disclosed in the present application, which should be included in the protection scope of the present application. Therefore, the protection scope of the present application should be based on the protection scope of the claims.

What is claimed is:

1. A connection method for new energy photovoltaic wire harness protective layer, comprising:
step 1: providing a single-layer or multi-layer irradiated main cable and an irradiated branch cable, wherein a nominal cross-sectional area of a conductor of the branch cable is less than or equal to a nominal cross-sectional area of a conductor of the main cable;
step 2: applying adhesive to outer surfaces of the main cable and branch cable, or first sleeving outer surfaces of the main and branch cable with heat shrink tubing and heating the heat shrink tubing to wrap around outer surfaces of the main cable and the branch cable;
step 3: connecting the main cable and branch cable into a cross-shaped or T-shaped by ultrasonic welding or by adding transition pieces;
step 4: wrapping outer surfaces of connected main cable and branch cable with adhesive to form a single-layer or multiple-layer protective layers; wherein the protective layer is made of thermosetting or thermoplastic material;
wherein the adhesive or heat shrink tubing is used to bond a cable insulation layer with the protective layer to achieve sealing and prevent the cable insulation layer from retracting.

2. The connection method for new energy photovoltaic wire harness protective layer according to claim 1, wherein the conductors of the main cable and branch cable are one of copper conductors, aluminum conductors, or copper-clad aluminum conductors.

3. The connection method for new energy photovoltaic wire harness protective layer according to claim 1, wherein the thermosetting material is at least one of epoxy-based materials, phenolic based materials, or polyester based materials.

4. The connection method for new energy photovoltaic wire harness protective layer according to claim 1, wherein the thermoplastic material is Thermoplastic Rubber, (TPV) materials or Polypropylene, (PP) class materials.

5. The connection method for new energy photovoltaic wire harness protective layer according to claim 1, wherein the protective layer is a single-layer structure or a multi-layer composite structure.

6. The connection method for new energy photovoltaic wire harness protective layer according to claim 1, wherein when using adhesive in step 2, the adhesive is directly applied to an outer surface of the cable insulation layer;
when using heat shrink tubing in step 2, the heat shrink tubing is tightly wrapped around the outer surfaces of the main cable and branch cable by heating.

7. The connection method for new energy photovoltaic wire harness protective layer according to claim 1, wherein the connection way between the main cable and the branch cable is selected as a cross-shaped connection or a T-shaped connection according to actual wiring requirements.

8. The connection method for new energy photovoltaic wire harness protective layer according to claim 1, wherein the method is used for cable connection and sealing protection in long-term outdoor use scenarios of new energy photovoltaic systems.
